(19) United States
(12) Patent Application Publication
(10) Pub. No.: US 2002/0181229 A1
(43) Pub. Date: Dec. 5, 2002

(54) Beam structure of dividing screen

(76) Inventor: Wayne Wei, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/861,606

(22) Filed: May 22, 2001

(51) Int. Cl. F21S 8/00

(52) U.S. Cl. 362/147; 362/152; 362/219; 362/225; 362/260; 362/368

(57) ABSTRACT

The present invention proposes an improved beam structure of a dividing screen, which comprises two stand pillars, a connecting pillar, a beam, and a reinforcing part. A flat board is disposed in the beam. A gutter is disposed on a middle portion of the flat board. Two guide grooves are formed at two sides of the gutter, respectively. An outer edge of each guide groove forms a locking board to join a lamp. A locating portion is formed between the gutter and each guide groove so that a bottom end portion of the reinforcing part can be disposed thereon. Thereby, reinforcement effect can be enhanced, and delicacy and visual effect can be increased.

### FIELD OF THE INVENTION

The present invention relates to an improved beam structure of a dividing screen and, more particularly, to a structure capable of enhancing reinforcement effect.

### BACKGROUND OF THE INVENTION

Generally, delicacy and visual effect are not taken into account when designing the beam structure of a dividing screen. Moreover, the beam structure has no reinforcement effect. Additionally, illumination facilities (e.g., illumination lamps) cannot be arranged thereon. Therefore, there are very few customers who select to use dividing screens.

Accordingly, the present invention aims to provide an improved beam structure of a dividing screen, which has illumination facilities provided thereon and also enhanced reinforcement effect.

### SUMMARY OF THE INVENTION

One object of the present invention is to provide an improved beam structure of a dividing screen, wherein a flat board is disposed in a beam, and a gutter is disposed on a middle portion of the flat board. Two guide grooves are formed at two sides of the gutter, respectively. An outer edge of each guide groove forms a locking board to join a lamp. A locating portion is formed between the gutter and each guide groove so that a bottom end portion of a reinforcing part can be disposed thereon. Thereby, reinforcement effect can be enhanced, and illumination facilities can be provided thereon.

Another object of the present invention is to provide a beam structure of a dividing screen capable of increasing delicacy and visual effect.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of the present invention;

FIG. 2 is a perspective view of the present invention;

FIG. 3 is a cross-sectional view of the present invention;

FIG. 4 is a perspective view according to an embodiment of the present invention;

FIG. 5 is a side view according to an embodiment of the present invention;

FIG. 6 is a perspective view according to a second embodiment of the present invention;

FIG. 7 is a perspective view according to a third embodiment of the present invention;

FIG. 8 is a cross-sectional view according to a third embodiment of the present invention;

FIG. 9 is a perspective view according to a fourth embodiment of the present invention;

FIG. 10 is a cross-sectional view according to a fourth embodiment of the present invention;

FIG. 11 is a perspective view according to a fifth embodiment of the present invention;

FIG. 12 is a perspective view according to a sixth embodiment of the present invention;

FIG. 13 is an exploded perspective view according to a seventh embodiment of the present invention;

FIG. 14 is a cross-sectional view according to a seventh embodiment of the present invention;

FIG. 15 is an exploded perspective view according to a eighth embodiment of the present invention; and

FIG. 16 is a cross-sectional view according to a eighth embodiment of the present invention.

### DETAILED DESCRIPTION OF THE PREFERRED EMBODIMENTS

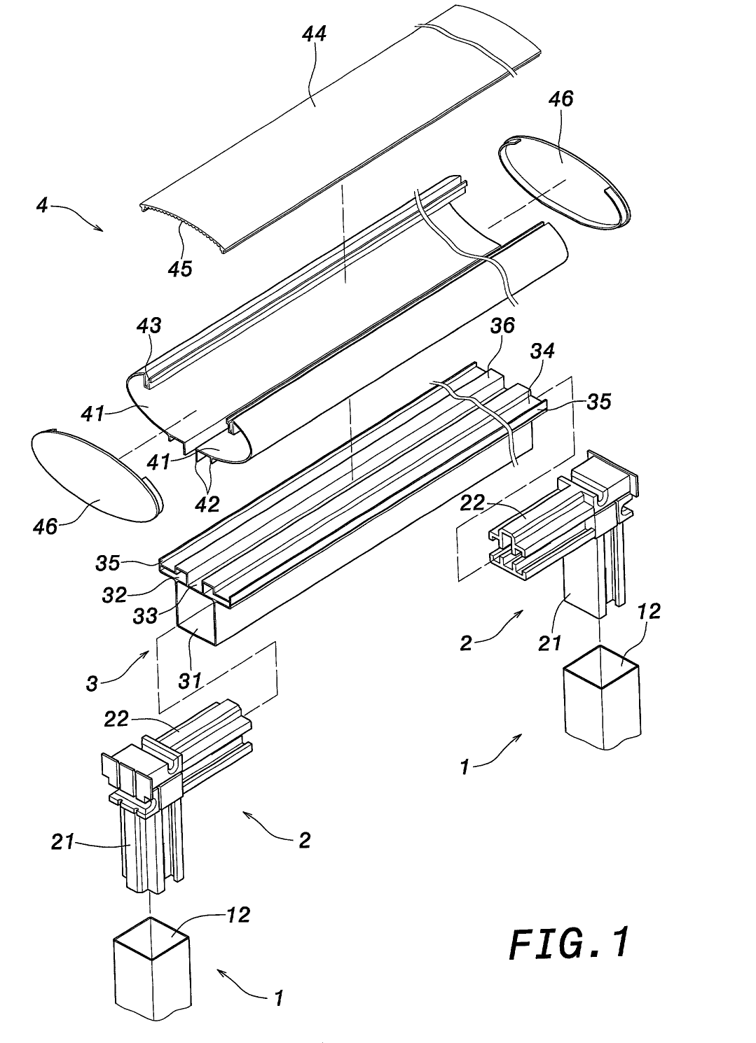

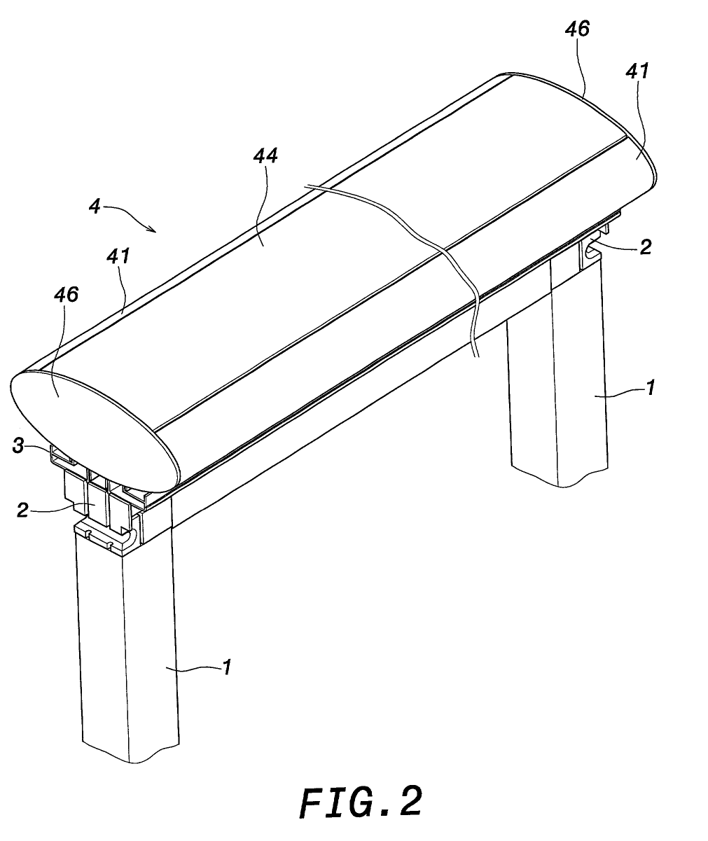

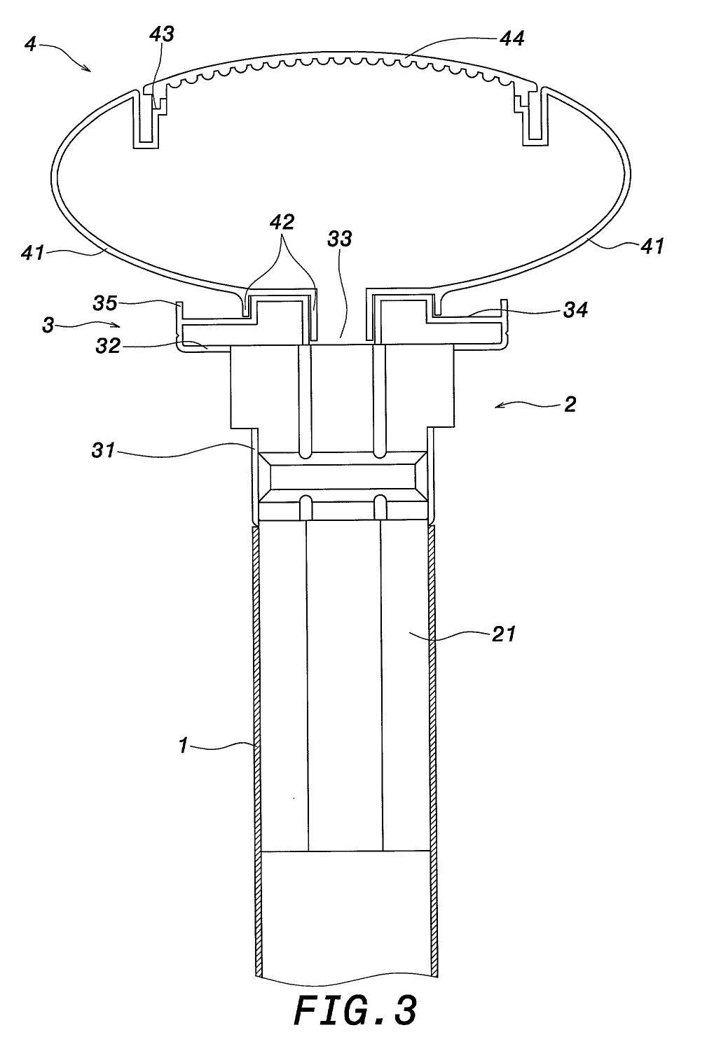

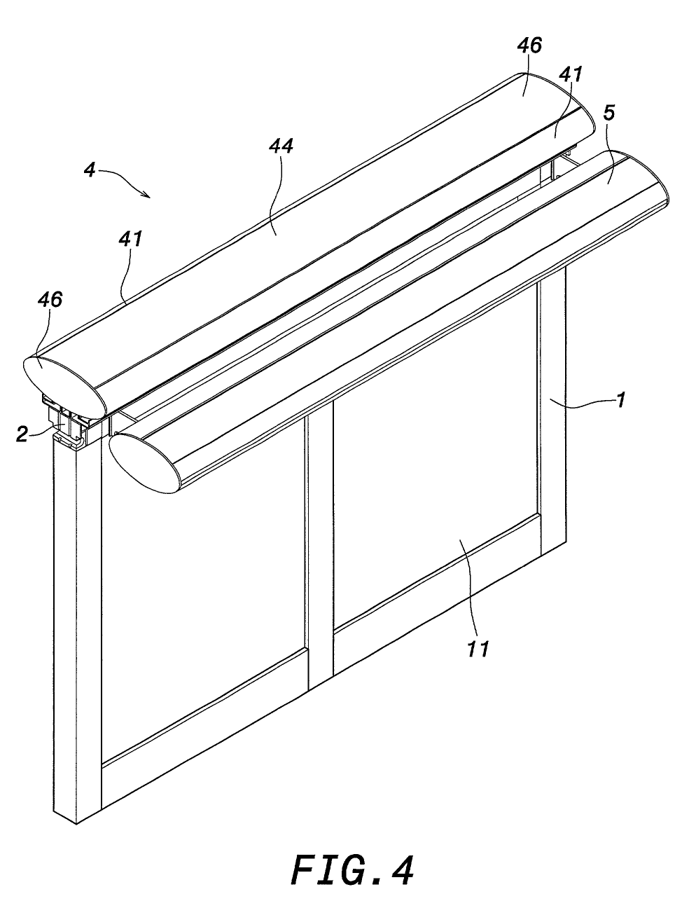

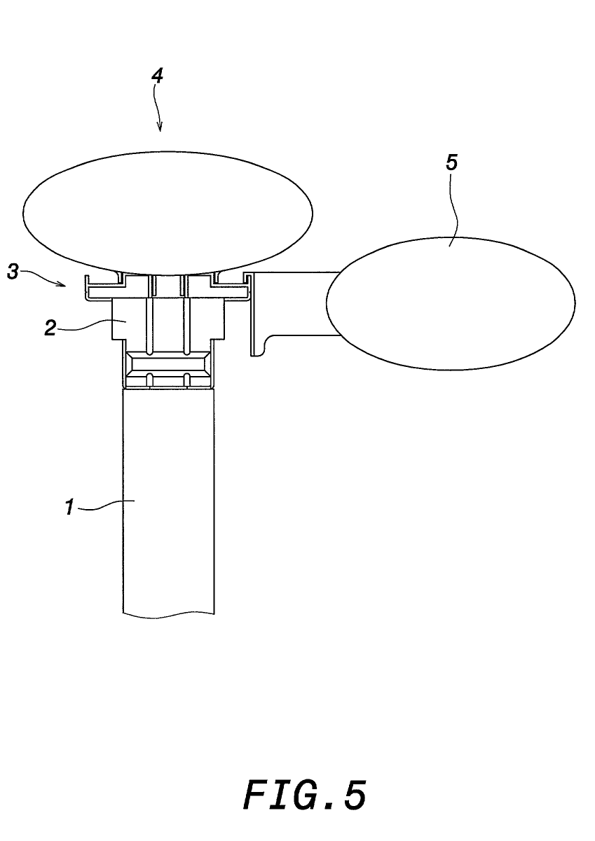

As shown in FIGS. 1 to 5, an improved beam structure of a dividing screen of the present invention comprises two stand pillars 1, two connecting pillars 2, a beam 3, and a reinforcing part 4.

A screen panel 11 is joined between the two stand pillars 1. Each stand pillar 1 has a hollow pillar hole 12 therein.

A lower end portion 21 of each connecting pillar 2 is received in the corresponding pillar hole 12 of the stand pillar 1. A side end portion 22 of each connecting pillar 2 joins a bottom end of the beam 3.

The beam 3 has a hollow bearing board 31 therein to connect the side end portion 22 of each connecting pillar 2. A flat board 32 is fixedly disposed on an upper surface of the bearing board 31. A gutter 33 is formed in a middle portion of the flat board 32. Two guide grooves 34 are disposed at two sides of the gutter 33, respectively. An outer edge of each guide groove 34 is extended to form a locking board 35 to join a lamp 5. A locating portion 36 is formed between the gutter 33 and each guide groove 34 so that a bottom portion of the reinforcing part 4 can be disposed thereon.

The reinforcing part 4 has two corresponding curved boards 41 therein. Two locating boards 42 of different sizes are fixedly disposed at a bottom edge of each curved board 41 to lap two side faces of the locating portion 36. A locating groove 43 is disposed at an upper edge of each curved board 41. A cover board 44 made of transparent material is disposed in a room formed by the two locating grooves 43. Bumps 45 in matrix form are disposed on an inner face of the cover board 44. A side board 46 is joined in a room formed by each side of the two curved board 41 and the cover board 44.

Thereby, reinforcement effect can be enhanced, and delicacy and visual effect can be increased.

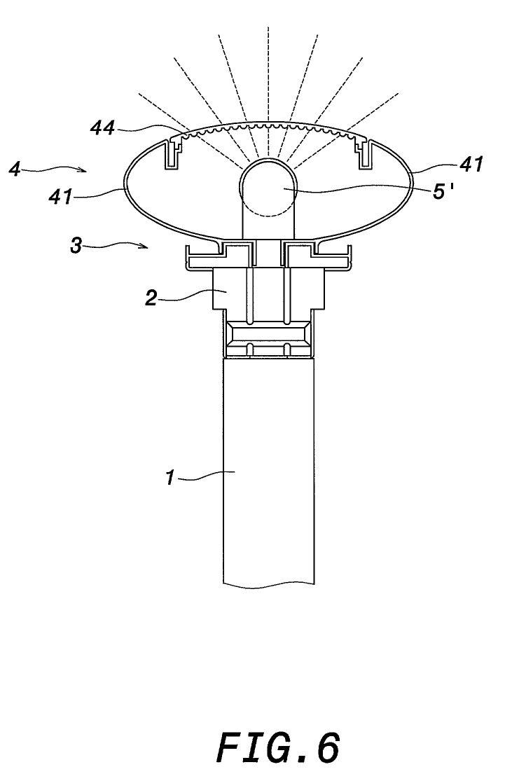

As shown in FIG. 6, a lamp 5′ can be joined in the reinforcing part 4 so that light emitted by the lamp 5′ can diverge out of the cover board 44.

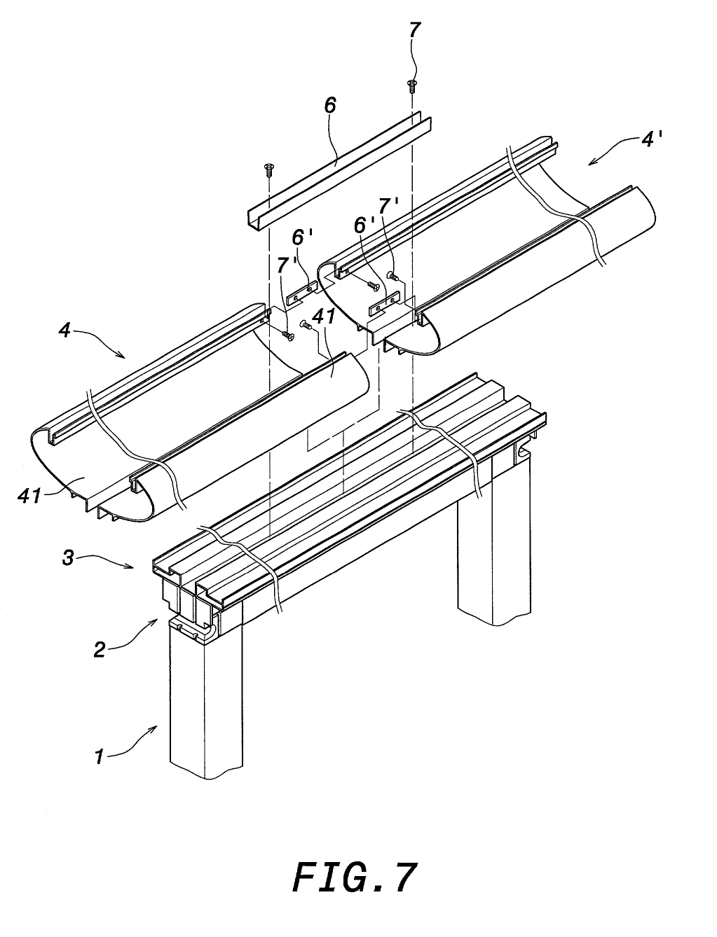

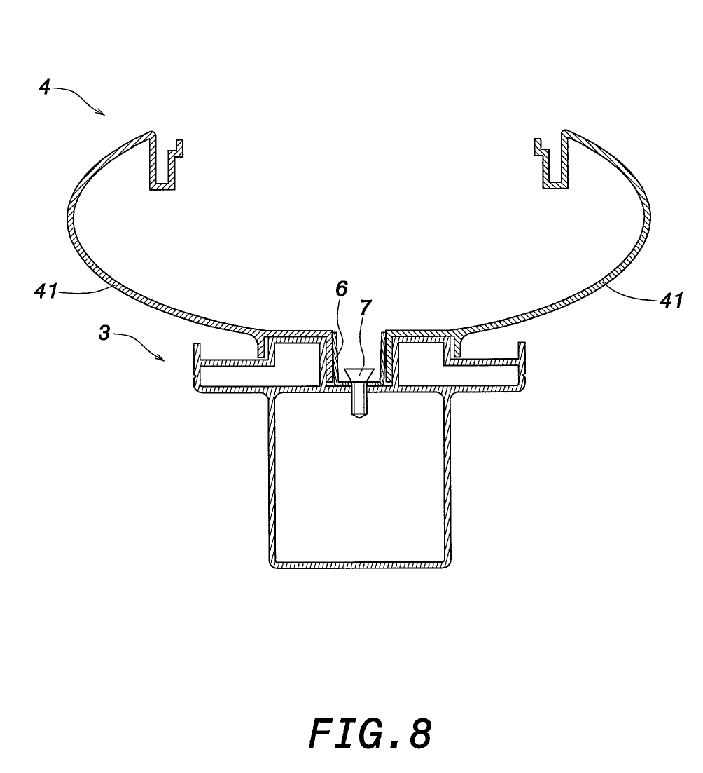

As shown in FIGS. 7 and 8, two reinforcing parts 4 and 4′ can be disposed on the flat board 32 of the beam 3 through a concave connecting part 6 matched by a locking part 7. Also, the curved boards 41 of the two reinforcing parts 4 and 4′ can be joined together in the two adjacent locating grooves 43 through connecting sheets 6′ matched by locking parts 7′, respectively.

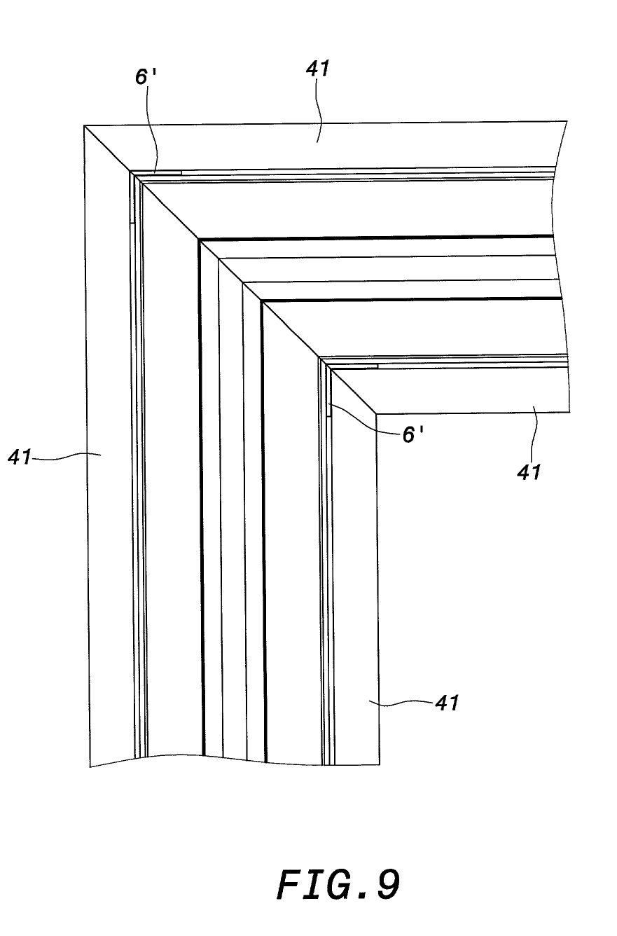

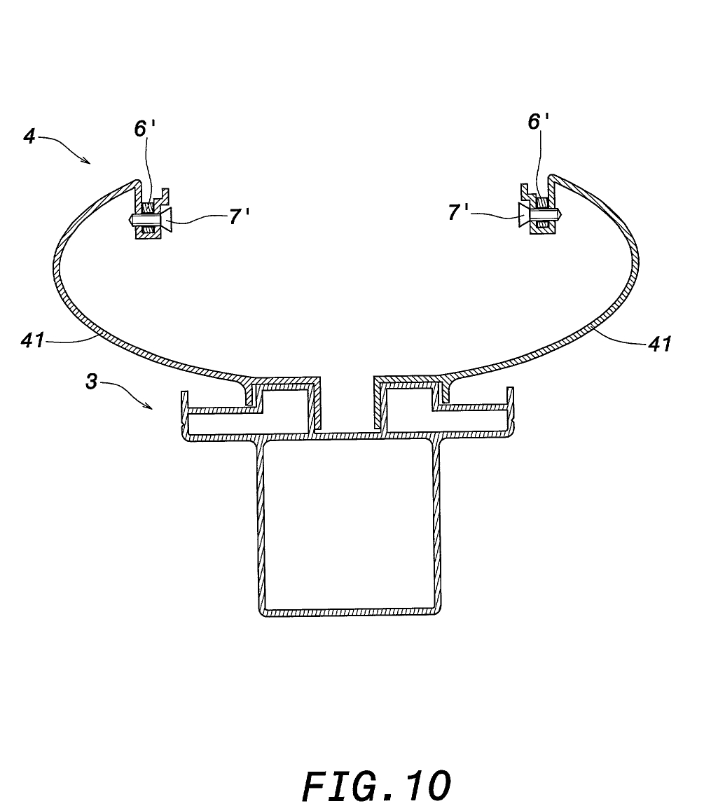

As shown in FIGS. 9 and 10, the curved boards 41 of the two reinforcing parts 4 can also be assembled together through L-shaped connecting sheet 6′ matched by the locking parts 7′, respectively.

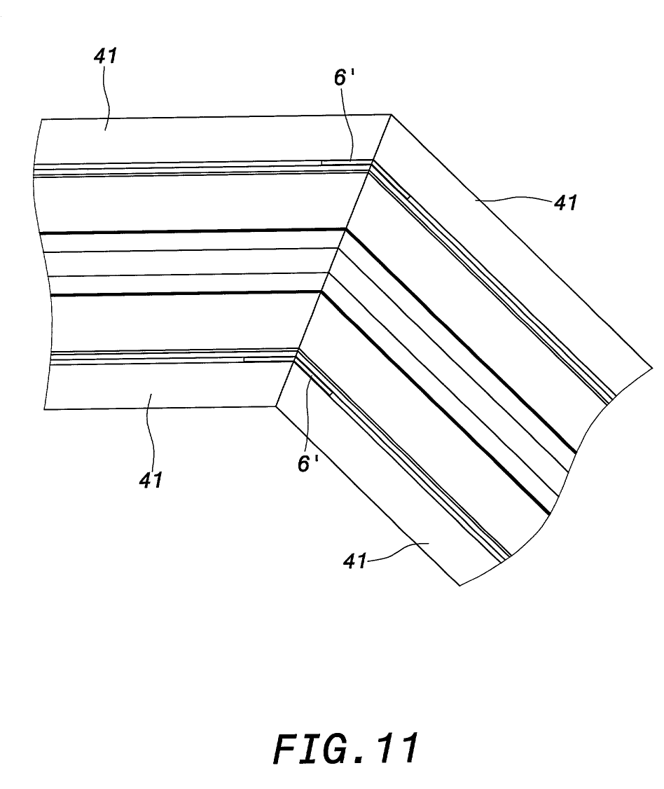

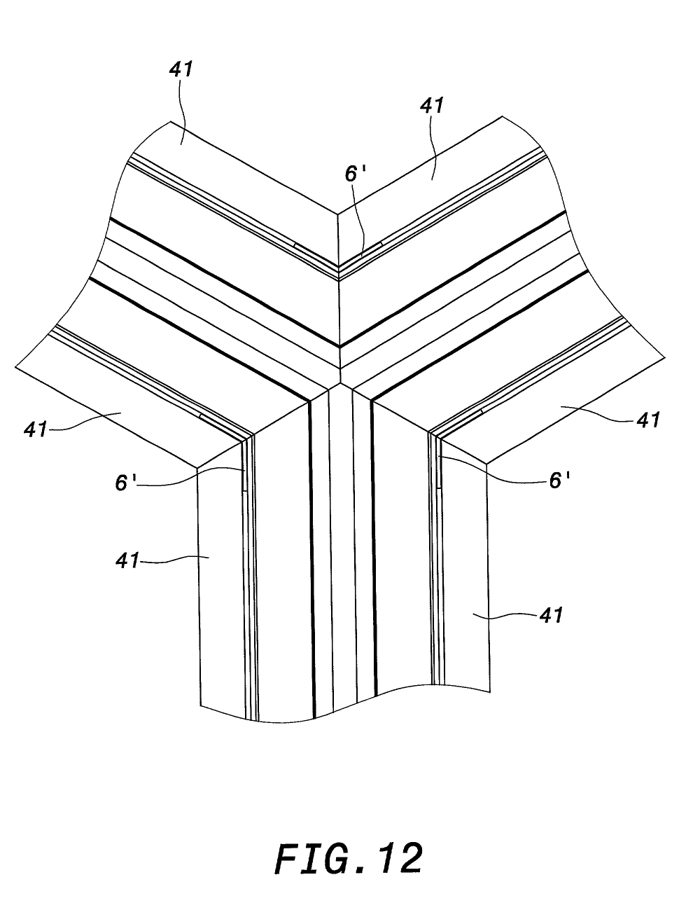

As shown in FIG. 11 or 12, the curved boards 41 of the two reinforcing parts 4 can also be assembled together through connecting sheets 6′ of different angle (e.g., 120 or 135 degrees) matched by the locking parts 7′.

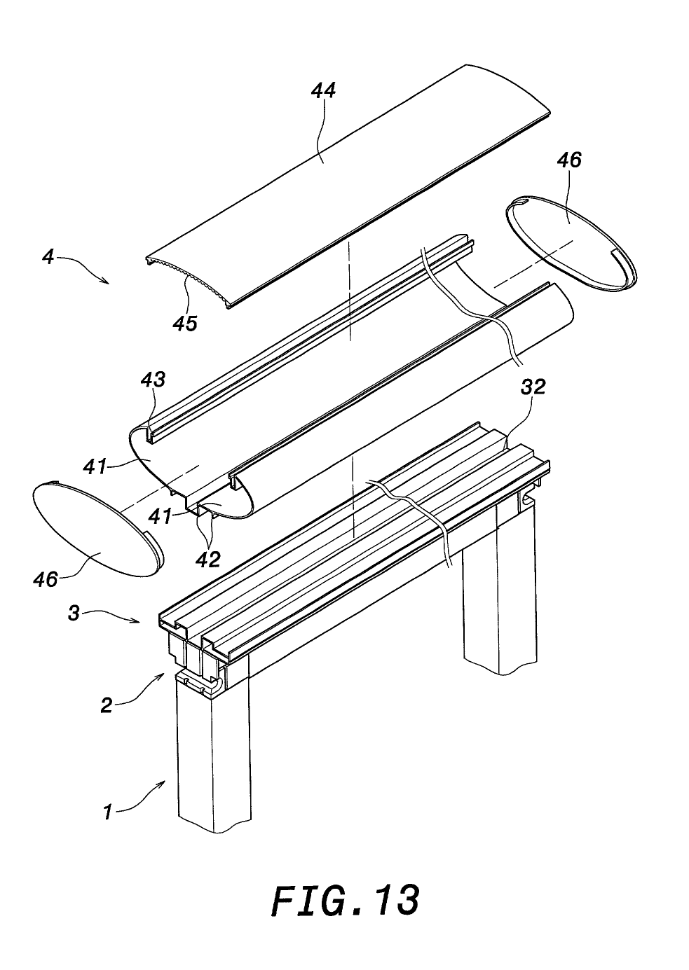

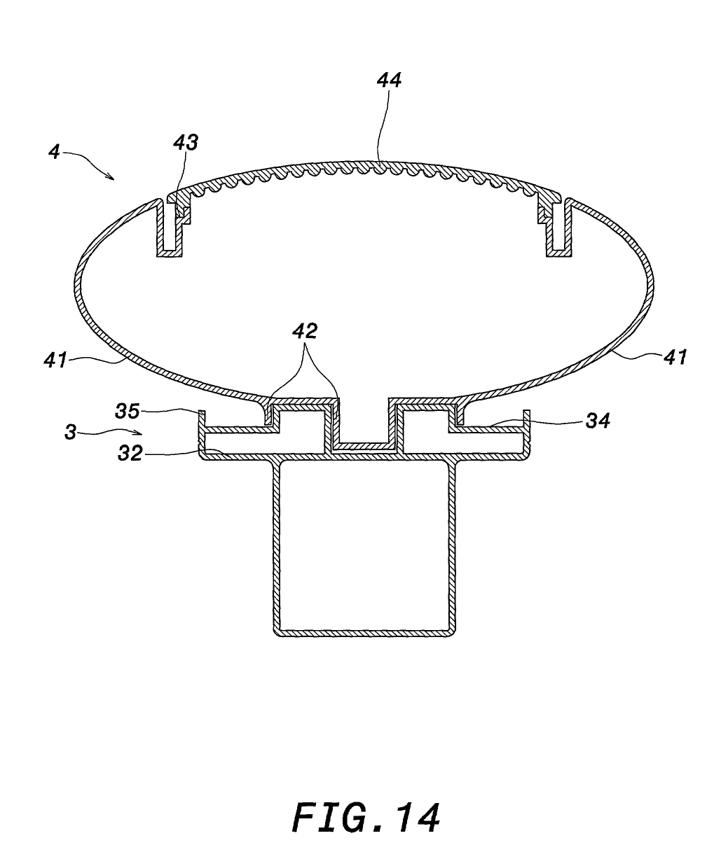

As shown in FIGS. 13 and 14, the two curved boards 41 can also be integrally formed to exactly assemble with the flat board 32 of the beam 3 to increase convenience.

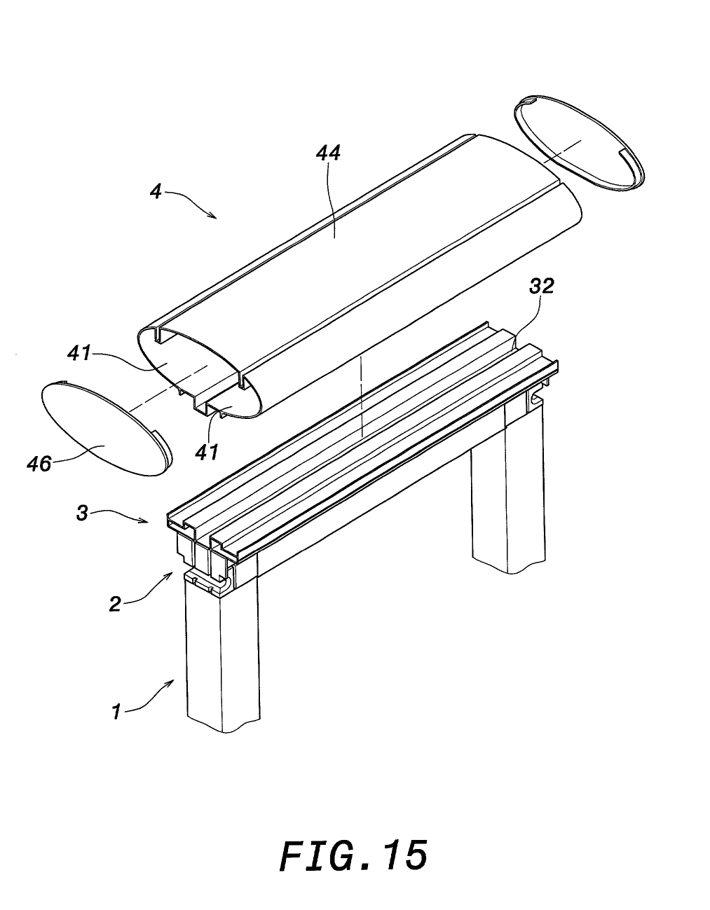

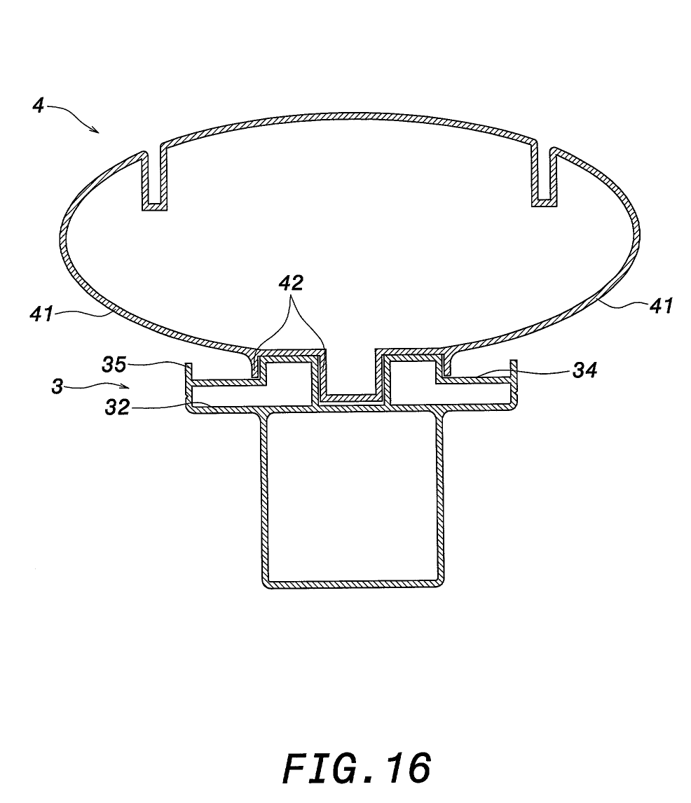

As shown in FIGS. 15 and 16, the cover board 44 and the two curved boards 41 can also be integrally formed to directly assemble with the flat board 32 of the beam 3.

To sum up, the present invention has the following characteristics.

(1). Reinforcement effect can be enhanced.

(2). Illumination lamps can be provided thereon.

(3). Assembly is more convenient.

(4). Delicacy and visual effect can be increased.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An improved beam structure of a dividing screen comprising two stand pillars, two connecting pillars, and a beam, a lower end portion of each said connecting pillar being joined with an upper end portion of said stand pillar, a side end portion of each said connecting pillar being joined with said beam; wherein the improvement of said improved beam structure is that an upper surface of said beam is joined with a plurality of reinforcing parts.

2. The improved beam structure of a dividing screen as claimed in claim 1, wherein said beam has a hollow bearing board disposed thereon, said bearing board having a flat board fixedly disposed thereon, a middle portion of said flat board having a gutter, either side of said gutter having a guide groove, an outer edge of each said guide groove being extended to form a locking board, said gutter and each said guide groove having a locating portion formed between them so that a bottom end portion of said reinforcing part can be disposed on said locating portion.

3. The improved beam structure of a dividing screen as claimed in claim 1, wherein each said reinforcing part has two corresponding curved boards therein, a bottom edge of each said curved board being fixedly provided with two locating boards of different sizes to lap two side faces of a locating portion, an upper edge of each said curved board having a locating groove, a room formed between said two locating grooves being provided with a cover board, an inner face of said cover board having a set of bumps, a room formed by each side of said two curved boards and said cover board being joined with a side board.

4. The improved beam structure of a dividing screen as claimed in claim 3, wherein a lamp can be joined in each said reinforcing part so that light from said lamp can diffuse out of said cover board.

5. The improved beam structure of a dividing screen as claimed in claim 3, wherein said two adjacent reinforcing parts can be assembled with said beam through a connecting part and a locking part.

6. The improved beam structure of a dividing screen as claimed in claim 3, wherein said locating grooves of said two adjacent reinforcing parts can be assembled together through a connecting sheet and a locking part.

7. The improved beam structure of a dividing screen as claimed in claim 3, wherein said two curved boards can be integrally formed.

8. The improved beam structure of a dividing screen as claimed in claim 3, wherein said cover board and said two curved boards can be integrally formed.
